(19) United States
(12) Patent Application Publication
(10) Pub. No.: US 2013/0105515 A1
(43) Pub. Date: May 2, 2013

(54) DISPENSER SYSTEM

(71) Applicant: Plas-Pak Industries, Inc., Norwich, CT (US)

(72) Inventors: Charles M. Frey, Bozrah, CT (US); Steve Raczka, Bozrah, CT (US)

(73) Assignee: Plas-Pak Industries, Inc., Norwich, CT (US)

(21) Appl. No.: 13/667,853

(22) Filed: Nov. 2, 2012

Related U.S. Application Data
(60) Provisional application No. 61/661,402, filed on Jun. 19, 2012.
(60) Provisional application No. 61/622,296, filed on Apr. 10, 2012.
(60) Provisional application No. 61/554,619, filed on Nov. 2, 2011.

(51) Int. Cl. B65D 83/76; B65D 51/20; B29C 45/16; B65B 3/04

(52) U.S. Cl. 222/137; 141/2; 264/250; 222/327; 222/386; 222/541.9; 222/387

(57) ABSTRACT

Disclosed herein is an apparatus for storing and dispensing a product and methods of making the apparatus and methods of assembling the apparatus. In one embodiment is a latch system for a two-component, side-by-side cartridge apparatus in which each cartridge is sealed by a compatibly configured piston. Traversal of the piston over the latch forms a sealed filling end.

### CROSS-REFERENCE TO RELATED APPLICATIONS

This application claims the benefit of U.S. Provisional Application No. 61/661,402, filed on Jun. 19, 2012, U.S. Provisional Application No. 61/622,296, filed on Apr. 10, 2012, and U.S. Provisional Application No. 61/554,619, filed on Nov. 2, 2011, each of which are incorporated by reference in their entirety.

### FIELD

This disclosure generally relates to a dispenser system comprising a latch for maintaining a piston inside the dispenser and preventing accidental release of a material.

### BACKGROUND

It has become customary to package sealant, adhesive, mastic, caulking, and other liquids (all of which are embraced herein by the term “liquid composition”) in dispensers that are adapted to be loaded into an extruding device in order to dispense the composition. The dispenser generally comprises a cartridge, a movable piston, and an extruding device that moves the piston through the cartridge, such as a caulking gun. The dispenser can be a one component cartridge or a two component cartridge joined together at a nozzle end in a side-by-side arrangement. The piston generally provides a movable seal against the interior of the cartridge.

Liquid compositions have different rates of thermal expansion and contraction. When a liquid composition in a sealed dispenser is heated or when atmospheric pressure is reduced, volume expansion can exert a force against a piston and push a piston out of the back end of the cartridge. Further, upon expansion and contraction of the composition, air can be sucked into the cartridge and cause unwanted air bubbles. In air curable compositions, entry of air into a sealed dispenser can cause hardening portions that can block the extrusion of the composition from the dispenser.

Additionally, transportation conditions can affect the integrity of a liquid composition in a sealed dispenser. For example, when a shipping box containing a dispenser is dropped during transport, a seal created by a piston can pop out of the cartridge.

Recently, many countries have implemented international trade regulations for the transport of dispensers containing hazardous liquids. For example, UN Recommendations on the Transport of Dangerous Goods advises that a hazardous filled cartridge sealed by a moveable piston should have a system that minimizes the release of its content when exposed to variations in pressure and temperature, and other transport conditions.

Various systems have been implemented for liquid filled cartridges sealed by a moveable piston with limited success and drawbacks, such as added costs, additional components, and assembly time. For example, adding a separate reinforcing member such as an end cap or sealing tape adds an additional component to the assembly, increases cost of manufacture, and requires an end user to remove the reinforcing member. Crimping the open end of a tube to prevent a piston from separating off can result in damage to the seal or tube. Punching a hole and placing a rod through the open end of a tube to prevent the piston from falling out adds an additional assembly step, additional cost, impedes packaging, and requires an end user to remove the rod. Back-up rings have been used with limited success. Back-up rings generally extend in a continuous annular pattern around the inner perimeter tube. Back-up rings can require a specialized piston, increase the risk of damage to the piston, and do not allow a user to easily remove the piston once the piston moves past the back-up rings.

Prior dispenser systems have also implemented systems for releasing the material from the dispenser end with limited success and drawbacks. For example, prior systems require a user to use a separate tool, such as a cutting tool or a screwdriver, to unseal a cartridge and release the material from the dispenser. There is therefore a need for a dispenser that is easy to manufacture, requires minimal assembly, and protects against impact from accidental rupture such caused by environmental variations and transport conditions.

Further, prior two-component side-by-side cartridges have implemented pull tab systems with drawbacks. For example, some prior systems require simultaneous removal of a single pull tab covering both nozzle openings. Other systems are not able to reseal itself after initial use. There is therefore a need for a two-component side-by-side cartridge with a pull tab system that allows for separate or simultaneous release of each component.

Additionally, prior two component side-by-side cartridges have implemented capping systems at the dispenser end with limited success. For example, prior systems have attempted to use frangible plugs that break off to unseal a nozzle end with the frangible plugs alleged to be able to reseal the nozzle end. However, such frangible plugs have been found to be ineffective in resealing a two component system and are vulnerable to premature breakage. There is therefore a need for a cap for a two component cartridge that protects a nozzle end having, for example, a pull tab system, as well as the same cap being able to effectively reseal a nozzle end.

### SUMMARY

In one embodiment, a two-component, side-by-side cartridge apparatus, for storing and dispensing a product is disclosed. Each cartridge is sealable by a compatibly configured piston, and each cartridge comprises a dispensing end, a filling end, and a substantially rigid tube section. The dispensing end and filling end are located at opposite ends of the tube section along a longitudinal axis. The tube section comprises an exterior and interior surface, a cavity section, and at least one latch system proximal to the filling end. The latch system comprises a resiliently bendable latch, a latch entry end, a vent, and a casing. The latch connectively hinged to the casing at the latch entry end. The latch extends into the cavity section towards the dispensing end. The perimeter of the latch and casing define the area of the vent. The vent is initially in fluid communication with the exterior and interior surface, and traversal of the piston over the latch forms a sealed filling end.

Also disclosed herein are methods for assembling an apparatus for storing and dispensing.

### BRIEF DESCRIPTION OF THE FIGURES

FIG. 1 is a longitudinal cross sectional view of a dispenser system.

FIG. 2 provides an enlarged isometric view of an interior of the first latch embodiment.

FIG. 3 provides an enlarged isometric view of an exterior of the first latch embodiment.

FIG. 4 provides an enlarged cross sectional view of the first latch embodiment.

FIG. 5 provides an isometric view of an interior of the second latch embodiment.

FIG. 6 provides an exterior view of the second latch embodiment.

FIG. 7 provides an enlarged cross sectional view of the second latch embodiment.

FIG. 8 provides enlarged isometric view of an interior of a third embodiment of the latch system.

FIG. 9 provides an enlarged isometric view of an exterior of a fourth embodiment of the latch system.

FIG. 10 provides an enlarged cross sectional view of the fourth embodiment of the latch system.

FIG. 11 provides an isometric view of the first pull-tab embodiment.

FIG. 12 provides a top view of the first pull tab embodiment.

FIG. 13 provides an isometric view of a second pull tab embodiment.

FIG. 14 provides an isometric view of a third pull tab embodiment.

FIG. 15 provides an isometric view of a first cap embodiment.

FIG. 16 is a top view of the first cap embodiment.

FIG. 17 is a cross sectional view of the first cap embodiment.

### DETAILED DESCRIPTION

A dispenser system has been discovered comprising a cartridge and a piston, the cartridge having a nozzle end and a filling end, tube section, cavity and a latch system integral with the tube section proximal to the filling end, in which the latch allows a piston to be received into the filling end to form a sealed filling end, while the latch restricts movement of the piston from reversing out of the filling end. The latch system can include a latch and a vent. The latch can include an elastic section that protrudes into the interior of the cavity to form a ridge, wherein the elastic section is of a distance to engage the piston. The latch can protrude at a forward angle that adjusts to allow a piston to traverse over the surface of the latch when the piston is inserted into the filling end of the tube. After the piston traverses over the latch, the latch returns to its initial position protruding into the interior of the cavity, and a sealed filling end is formed. After the sealed filling end is formed, the forward angle can remain substantially stationary to restrict the reversal of the piston from the filling end and maintain the seal. A flange can extend off of the ridge to provide additional surface area for a point of contact between the latch and piston that restricts the reversal of the piston.

In an embodiment, the latch can include a supporting section that buttresses the elastic section. The supporting section can extend from the ridge and connect to the tube so that latch forms at least two points of attachment to the tube along the longitudinal axis with the ridge of the latch extending into the interior of the cavity. In an alternative embodiment, the supporting section can also extend from just below the ridge and connect to the tube. The supporting section can further restrict the adjustability of the forward angle after the piston traverses over the latch and forms a sealed filling end. The supporting section can comprise of one or more sections with one or more joints. The supporting section can adjust in response to movement of the elastic portion.

A vent can adjoin the latch along the perimeter of the latch. The vent can be in fluid communication with the interior and exterior of the tube. The vent can be a self-closing vent that allows for releasing any trapped air or excess liquid in the cavity as the piston engages the latch, and is sealed by the traversal of the piston over the latch. The sealed filling end can be made reversible by disengaging the latch so as to reverse the movement of the piston out of the filling end.

The latch system is positioned towards the filling end of the dispenser. The latch can be in the form of an elastic member. The latch can be in the shape of bow, a semicircular arc-like pattern, a hook, a crescent, or any raised surface that extends into the tube. The latch can have one or more indentations, teeth, or grooves to provide resistive friction against the piston from reversing direction out of the tube. The shape of the latch is configured to facilitate movement of the piston towards the nozzle end, while restricting movement of the piston over the latch in the reverse direction.

In an embodiment, prior to insertion of the piston, the elastic member is at a first position. At the first position, a portion of the latch protrudes into the interior of the tube. When the piston is inserted, the piston contacts a leading edge of the elastic member and bends the elastic member to a second position. Further movement of the piston results in the elastic member bending to a third position. At the third position, the elastic member latches the piston inside the cartridge. In an embodiment, the first and third positions of the latch are substantially the same. If desired, removal of the piston can be accomplished by disengaging the elastic portion and manually pulling the piston out of the tube.

The number of latch systems can be varied for specific sizes of cartridges and products. For example, larger cartridges can require more than two latch systems so as to prevent accidental rupture. Smaller cartridges can be manufactured with one or two latch systems.

A first latch system can be located on one side of a cartridge and a second latch system can be located on the other side of the cartridge. Multiple latch systems can be placed diametrically opposed to each other along the sidewalls of the dispenser wall. For some applications, a two-latch system can be desirable so as to more easily allow a user to disengage the latches with his or her fingers and reverse the piston out of the tube. In other applications, a three or four latch system can be desirable for additional support. Latch systems can also be placed in a tube to accommodate specific fill volumes.

A self-closing vent in the dispenser can be varied for specific sizes of dispenser and product. The vent can surround the perimeter of the latch so as to connectively hinge the latch at two locations along the longitudinal axis of the cartridge, while having a middle section extending into the interior of the tube. The self-closing vent can comprise of one or more holes in fluid communication with the interior and exterior of the cartridge. The vent can be in the shape of two holes laterally surrounding the latch, with the latch extending into the tube along the perimeter adjoining the two holes.

In another embodiment, a one-way degassing valve or multiple valves can be included in the dispenser so as to permit release of air while retaining the liquid composition.

In an embodiment, one or more slots can be recessed into the interior of the tubular body so as to provide a channel for excess air and fluid to escape for when the piston enters the filling end. The channel can be a self-closing channel that is closed by the movement of the piston into the cavity. In an embodiment, a slot can be recessed into the filling end of the interior of the cartridge and extend along the longitudinal axis of the cartridge to a length equal to or less than the length of the piston. In such an embodiment, as the leading edge of the piston traverses over the latch system and into the interior of a filled cartridge, the slots assist in the removal of any built up pressure or fluids within a cartridge. As the trailing edge of the piston locks into the latch system, the leading edge of the piston traverses over the end of the slot to seal the cartridge.

The dispenser assembly can be in the form of a cartridge, a syringe, or other types of containers where a material is sealed at the filling end and then pushed out through a dispensing end. The dispenser can be for both single and plural component materials in single and multiple cartridges. Liquids can include including epoxy, polyurethanes, silicones, acrylics, adhesives, paints, pastes, and abrasive materials.

Additional components can be added to the dispenser, such as a pull-tab system. A pull-tab system can be integrally molded at the dispensing end to provide a seal. A user can remove the pull-tab with simple manual force, without the need for a separate knife of screwdriver, thereby allowing the user to easily dispense the content from the dispenser system.

For a multiple component dispensing systems, such as a side-by-side two component cartridge or coaxial cartridge, the pull tab system can comprise of tear ring, a double tear ring or other protruding designs separately attached to a removable panel portion on the nozzle end. The removable panel portion can be defined by a peripheral score line or weakened line along the nozzle end of the cartridge that assists in the removed from the cartridge. Each pull tab can be integral with the cartridge, or separately adhered to the nozzle end. Advantageously, a double tear-off ring vertically aligned with each other allows a user to remove the panel portions separately or simultaneously. In an embodiment for a side by side cartridge, the pull tab comprises of two oblong projecting prongs that break off from the nozzle and are complementary shaped to the orifice of the nozzle so as plug the orifice after initial use.

Further, an attachable cap for a nozzle end of a two component side-by-side cartridge can comprise of two reversibly fitting sections. The first section is an overcap housing that is adaptable to fit over the nozzle end and provide protection for a pull tab system. The cap can be removed from the nozzle end, rotated 180 degrees, and a second section in the form of a plug housing having two projecting plugs can be adapted to reseal the nozzle end of the cartridge.

The dispenser components can be made through injection molding, and other molding techniques well known in the art. The dispenser components can be made of a resiliently deformable plastic that provides for sufficient elasticity and strength of the latch to maintain piston sealed at the filling end. The cartridge and latch system can be monolithically formed from the same material. The latch can be made of a material different from the tube, and separately adhered to the tube. Likewise, the pull tab system can be monolithically formed or separately adhered to the tube. Additionally, the cap can be made of the same material or different from the tube, and separately adhered to the tube. Further, the cap can be made of a material that has a greater degree of flexibility than the cartridge. Alternatively, separate plugs can be adhered to the plug housing and the plugs can be made of a material that a greater degree of flexibility than the rest of the cap.

The dispenser components can be made of any resins that are nonreactive with the materials. Exemplary suitable resins include polypropylene (PP), linear low-density polyethylene (LLDPE), polypropylene copolymer (PP COPO), polyethylene terephthalate (PET), polystyrene, PVC, high-density polyethylene (HDPE), acrylic fiber, low density polyethylene (LDPE), and polyamide (PA or nylon). Likewise, the piston can be made of the same or similar resins. A resiliently deformable metal can be used in place of a plastic.

The dispenser can be modified in various configurations that adheres to inventive concepts described above.

Embodiments of the invention will now be described in detail.

Latch Systems

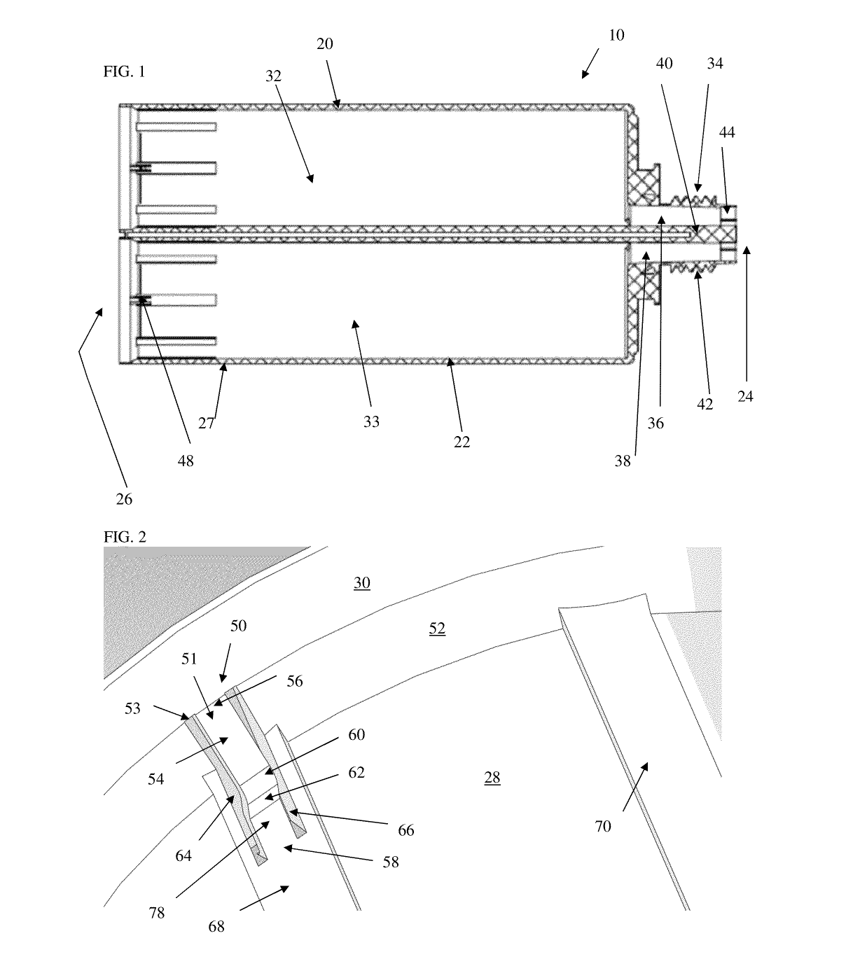

FIG. 1 shows a longitudinal cross sectional view of a dispenser system 10 that is two component, side-by-side dispenser. The dispenser system 10 comprises two generally cylindrical shaped cartridges, first cartridge 20 and a second cartridge 22, both joining together at a nozzle end 24. Each cartridge has a filling end 26 and a tube section 27. The first cartridge has first cavity 32 and the second cartridge has a second cavity 33.

A nozzle 34 is formed at the nozzle end 24. The nozzle 34 contains a first conduit 36 and a second conduit 38 with the first conduit in fluid communication with the first cavity 32, and the second conduit in fluid communication with the second cavity 33. A partition wall 40 maintains a seal separation between both conduits and cartridges. The nozzle 34 has external threading 42 and a sealed end 44. The seal end 44 provides a seal arrangement at the nozzle end of each the conduits, and the seal can be broken by removal of the sealed end 44. A mixing nozzle or cap (not shown) with internal threading can be threadably fitted over the nose 34. The nozzle 34 is integrally molded together with the tube. Towards the filling end 26 is a latch system 48.

FIGS. 2-4 provide a first embodiment 50 of a latch system. FIG. 2 provides an enlarged isometric view of the interior of the filling end of the cartridge and latch system. The latch system comprises a latch 51 and vents 64 and 66. The filling end of the cartridge comprises a sidewall 28, endwall 30, and a transition portion 52. The sidewall 28 and endwall 30 are integrally connected through the transition portion 52. The transition portion has a general frustroconical shape. This shape allows a piston to easily fit within the perimeter of the endwall and transition towards forming a closely fitted seal against the sidewall.

The sections of the latch system 50 will now be described in greater detail. The latch 51 connectively hinges to a casing 53 at a latch entry end 56 and a latch locking end 58. From the latch entry end 56 to the latch locking end 58 comprises an elastic portion 54 integral with and attached at one end of the tube via the latch entry end 56. On the opposing end of the elastic portion 54, the elastic portion extends into the interior of the cartridge and transitions to form a ridge section 60. The ridge section transitions to a supporting section that comprises a latch locking section 62 that projects back towards the inner wall of the cartridge and transitions to a bridge section 78 that reconnects the latch to the casing 53 at the latch locking end 58. The bridge section is substantially parallel with the longitudinal axis of the cartridge. As shown, the latch connectively hinges to the tube at opposing sides along the longitudinal axis of the casing at the latch entry end 56 and latch locking end 58 and extends into the interior of the tube.

The perimeter of the latch 51 and casing 53 define two vents, vents 64 and 66 adjoin a portion of the longitudinal boundary of the latch 51. As shown, the vents are in fluid communication between the interior and exterior of the tube. In this embodiment, the arrangement of the vents on opposing longitudinal sides of the latch allows the latch to resiliently bend in the direction towards the central axis of the cartridge.

FIG. 2 further shows two types of slots. A first slot 68 is recessed into the interior of the transition portion 52 and sidewall 28, with the two vents 64 and 66 and latch 51 partially embedded within the perimeter of the recessed slot. A second slot 70 is recessed into the interior of the transition portion 52 and sidewall 28, but does not have an embedded vent or a latch as in the first slot 68. The slots are recessed in order to assist in expelling air from the cavity through a channel created between the slot and piston as the piston traverses over the latch.

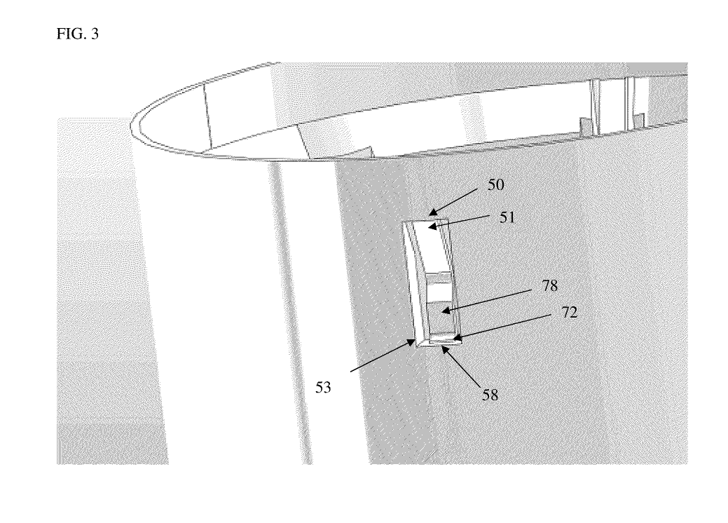

FIG. 3 provides an enlarged isometric view of an exterior view of the first latch system 50, positioned towards the filling end, showing the reverse side of the latch 50, bridge 78, casing 82, and a footing 72. The footing 72 provides reinforcement for the connection between the latch-locking end 58 and the casing 53.

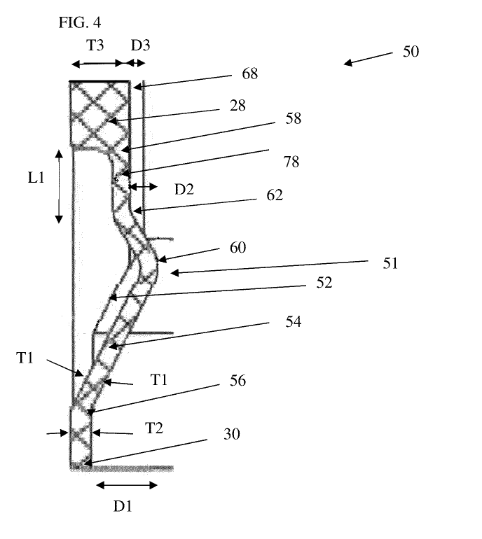

FIG. 4 provides an enlarged cross sectional view of the first latch embodiment 50. The latch 50 comprises the latch entry end 56, the elastic portion 54, the ridge section 60, the locking section 62, bridge 78, and latch locking end 58. The latch connects at opposite ends within the casing 53 at the latch entry end 56 and at the latch locking end 58. The latch entry end is generally flush with the endwall 30. The elastic portion 54 generally follows the frustroconical shape of the transition portion 52 and extends into the tubular cavity. The ridge section 60 extends into the tubular cavity by a distance D1 as measured from the interior surface of the latch entry end 56, and a distance D2 as measured from the interior surface of the latch locking end 58. The first slot 68 has a depth of D3. In this embodiment D2 is greater than D3, and D1 is greater than D2.

The elastic portion 54 has a thickness T1, the endwall has a thickness T2, and the sidewall has a thickness T3. In this embodiment, the elastic portion T1 is less thick than the sidewall T3. Further, the elastic portion thickness T1 is substantially the same as the endwall thickness T2. The elastic portion thickness T1 is generally thin enough to provide resilient flexibility to the elastic portion for when the piston traverses over the elastic portion and thick enough to resist reversal of the piston once the piston is latched into the cartridge. The endwall thickness T2, sidewall thickness T3, and transition portion generally have an optimal thickness so to maintain the integrity of the tube while allowing flexibility of the elastic portion. The length of the latch is substantially similar to the length of the vent. In FIG. 4, the vent (not shown) would extend a distance from the latch entry end 56 to the latch locking end 58. L1 provides a length as measured along the bridge 78 from the locking section 62 to the latch locking end 58. In this embodiment, in order to form a seal with a piston, the piston needs to be at least as thick as L1 so as to lock in the latch locking section 62 and cover the side vents and slot.

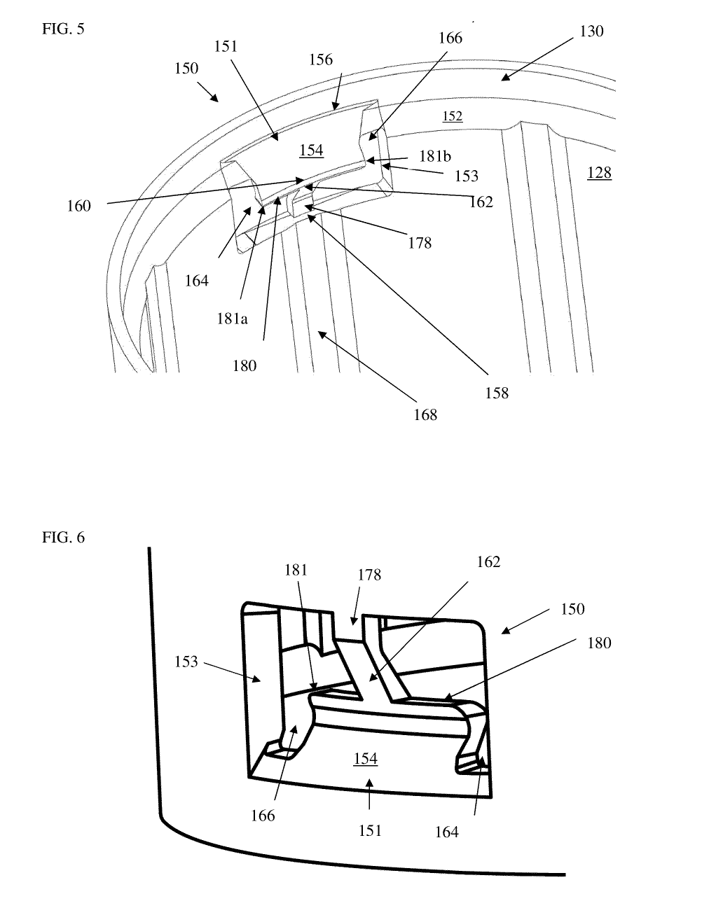

FIGS. 5-7 provide a second embodiment 150 of the latch system. FIG. 6 shows an enlarged isometric view of an interior of the filling end of a cartridge, showing the latch system having a latch 151 and vents 164 and 166. The latch 151 connects at opposite ends within the casing 153, proximate to the filling end via a latch entry end 156 and towards the dispensing end at a latch locking end 158. The latch comprises of an elastic portion 154 that extends into the cavity of the cartridge, and the elastic portion connects to a supporting section that reconnects with the cartridge at the latch locking end 158. The supporting section comprises a latch locking section 162 and bridge 178. In this embodiment, the elastic portion further comprises a flange 180, extending on opposing sides of the elastic portion to generally mirror the curvature of the tube wall. The flange 180 generally extends across the vents 164 and 166 towards the side walls of the casing 182. In this embodiment, the flange is tapered in order to allow a facilitated entry of the piston from the filling end.

FIG. 6 provides an exterior view of the latch system 150, showing the latch 151 attached within the casing at opposing ends and surrounded along its sides by vents 164 and 166. As shown in this embodiment, the flange 180 extends towards the side walls of the casing 153. The top portion of the flange forms a shelf 181. The shelf provides an additional point of contact and supporting means to further restrict the reversal of the piston once the piston traverses over the latch.

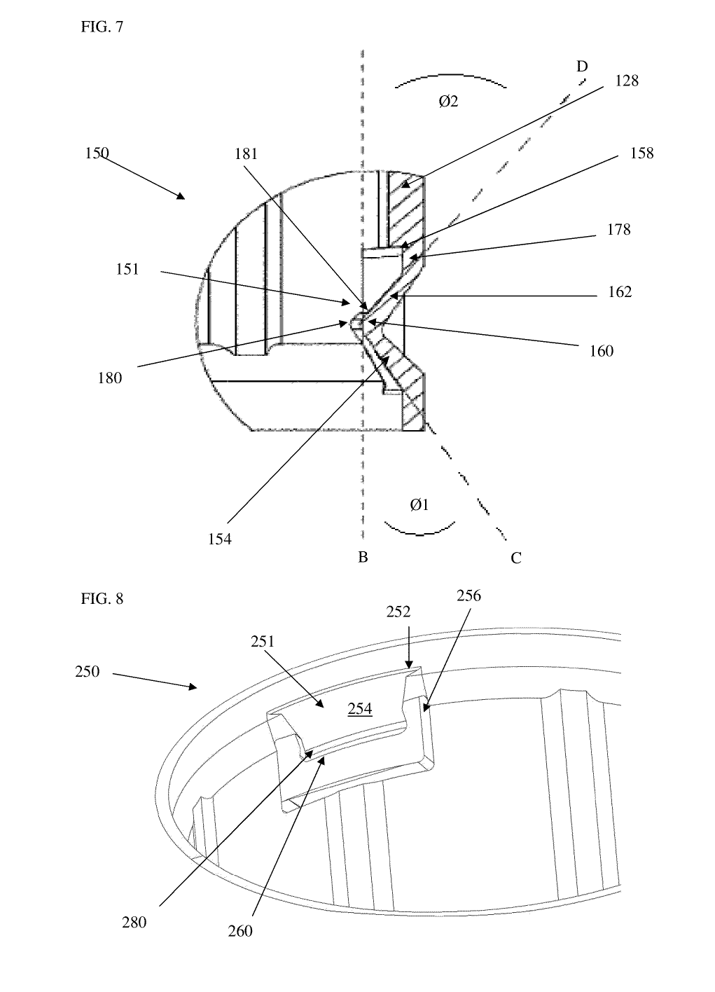

FIG. 7 provides an enlarged cross sectional view of the latch system 150 along the longitudinal axis of the cartridge through the sidewall 128, latch locking end 158, bridge 178, latch locking section 162, flange 180, shelf 181 and elastic portion 154.

Two angles are shown in FIG. 7. The forward angle θ1 is an angle formed from the longitudinal axis B of the cartridge and axis C of the interior surface of the elastic portion 154 in an axis extending from the latch entry end 156 to the flange 180. The forward angle can be adjustable. The forward angle can be adjustable from about 0 to about 90 degrees, specifically about 0 to 50 degrees, more specifically about 5 to 35 degrees. In a specific embodiment, the forward angle is initially no greater than 45 degrees and upon contact with the piston is adjustable to no less than 0 degrees. In a more specific embodiment, the forward angle is initially no greater than 35 degrees and upon contact with the piston is adjustable to no less than 0 degrees. In yet a more specific embodiment, the forward angle is initially no greater than 30 degrees and upon contact with the piston is adjustable to no less than 0 degrees.

The back angle θ2 is an angle that is formed from the longitudinal axis of the cartridge and an axis D extending along the latch locking section. As the forward angle is decreased, the back angle can remain substantially the same. The back angle can be about 0 to 90 degrees, specifically about 15 to about 55 degrees, even more specifically about 25 to 45 degrees, more specifically about 30 to 40 degrees.

A bridge angle (not shown) is formed from the longitudinal axis of the cartridge and the axis of the bridge 178, the axis of the bridge formed along the plane of the bridge extending from the point of connection to latch locking section 178 to the latch locking end 158. The bridge angle can be adjustable in response to the forward angle. In an embodiment, the bridge angle is initially substantially parallel with the longitudinal axis of the cartridge and upon contact of the piston against the latch, the bridge angle is adjustable to no greater than 45 degrees, even more specifically no greater than 35 degrees, and yet even more specifically no greater than 30 degrees.

The flange can be in a variety of configurations with the purpose being to engage and restrict the reversal of a piston once the piston traverses over the latch in a direction towards nozzle end. Likewise, the elastic portion can be configured in alternative arrangements to adapt to other dispenser configurations, and to restrict the reversal of the piston once the piston traverses over the latch (e.g., multiple elastic portions spanning the self-closing vent, etc.). Additionally, the bridge and latch locking section can be configured in alternative arrangements to connect with the elastic portion (e.g., multiple bridges connecting to the elastic portion, etc.).

In the two embodiments shown in FIGS. 2-7, the bridge section provides several advantages in the manufacturing of the latch system. First, in a dispenser made by mold injection, the bridge section minimizes manufacturing errors caused by the removal of a mandrel from the interior of a formed cartridge. Without a bridge, the elastic portion is more susceptible to catching and deforming on a mandrel exiting the formed cartridge, and swinging open in a manner similar to a hinged door. Second, the jointed arrangement of the latch components allows the latch to flex when the piston traverses over the latch, while providing resistive force for the latch to return to its original position after the latch locks the piston into the cartridge.

FIG. 8 provides a third embodiment 250 of a latch system. FIG. 8 shows an enlarged isometric view of an interior of the filling end of a cartridge. The elastic portion 254 of the latch 251 extends into the interior portion of the cartridge, and forms a flange 280 and a shelf 260 at the top of the flange 280. The shelf provides an additional point of contact and supporting means to further restrict reversal of the piston once the piston traverses the latch. In this embodiment, the shelf 260 is not connected to a supporting section, such as a latch locking section and bridge shown in previous embodiments.

In the third embodiment shown in FIG. 8, when a mandrel is removed from the filling end of the interior of the cartridge, the elastic portion is sufficiently tapered and resilient so as not to catch on an exiting mandrel during injection molding and flip open like a hinge door, while maintaining a sufficient flexibility to allow a piston to traverse and restrict reversal of the piston.

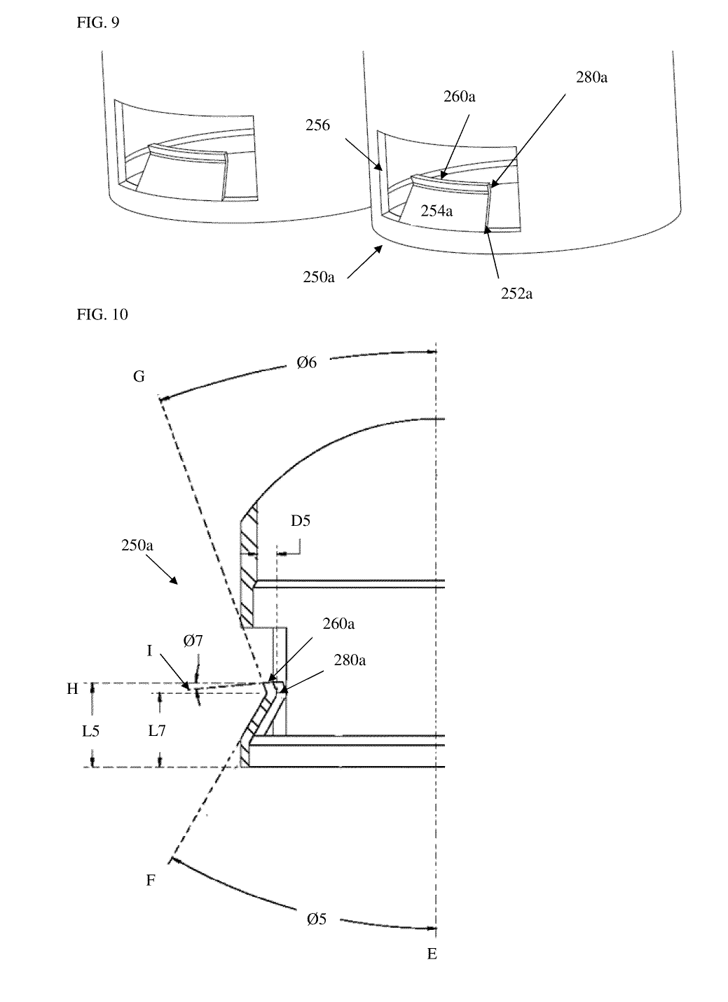

FIGS. 9 and 10 provide a fourth embodiment 250a similar to the third embodiment with an elastic portion 254a extending into the interior portion of the cartridge and a flange 280a and a shelf 260a. In this fourth embodiment, the latch attaches within the interior of the casing 256 at label 252a away from the corners, whereas in the third embodiment the latch connects to the cartridge wall at the corners of the casing at label 252. Three angles are shown in FIG. 10. The forward angle θ5 is an angle formed from the longitudinal axis E of the cartridge and axis F of the elastic portion in a plane extending from the latch entry end to the flange 260a. The forward angle is adjustable. In an embodiment, the forward angle is adjustable from about 0 to about 60 degrees, specifically about 0 to 45 degrees, more specifically about 0 to 30 degrees. In a specific embodiment, the forward angle is initially set to no greater than 45 degrees and is adjustable to no less than 0 degrees. In a more specific embodiment, the forward angle is initially set to no greater than 35 degrees and is adjustable to no less than 0 degrees. In yet even more specific embodiment, the forward angle is initially set to no greater than 30 degrees and is adjustable to no less than 0 degrees.

The flange angle θ6 is an angle that is formed from the longitudinal axis E of the cartridge and an axis G extending from the flange. The flange angle can be about 5 to 35 degrees, specifically about 10 to about 55 degrees, even more specifically about 15 to 25 degrees, more specifically about 18 to 22 degrees. In a specific embodiment, the flange angle is less than 25 degrees, while the forward angle is initially set to no greater than 35 degrees and is adjustable to no less than 0 degrees. In an even more specific embodiment, the flange angle is less than 22 degrees, and the forward angle is initially set to no greater than 30 degrees and is adjustable to no less than 0 degrees.

A shelf angle θ7 is the angle of the shelf. The shelf angle θ7 is formed between axis I and H. The shelf angle can be greater than 0 degrees, more specifically greater than 2 degrees, and even more specifically greater than or equal to 5 degrees. The flange 280a extends into the tubular cavity by a distance D5 as measured from the interior surface of the cartridge to the interior most portion of the flange. The latch thickness is generally thin enough to provide resilient flexibility to for when the piston traverses over the latch and thick enough to resist reversal of the piston once the piston is within the cartridge. In this embodiment, the length of the latch is less than the length of the vent. L5 provides a length as measured along the longitudinal axis from the filling end of the cartridge to the shelf. L7 provides a length as measured along the longitudinal axis from the filling end of the cartridge to the start of the flange.

It should be understood that even though the latch embodiments illustrated herein describes a dual cylindrical system, the latch can be used with any cylinder (e.g., singular cylinder, dual cylinder, snap together cartridges, etc.).

A piston (not shown) is formed to fit closely inside the tubular body. The piston complements the shape of the interior of the cartridge, traverses over the latch, and blocks the vent to form an air tight seal.

Assembly of the dispenser and piston can be achieved in the following manner. A piston is positioned over the filling end and a force slides the piston towards the latch. As the piston traverses over the latch, the latch bends towards the cartridge walls, and any excess air or liquids is expelled through the self-closing vents. After the piston traverses the latch, the latch resets itself to its initial position to lock the piston within the interior of the cartridge. At this position, the self-closing vent is now blocked by the piston and a seal at the filling end is established.

Pull-Tab Systems

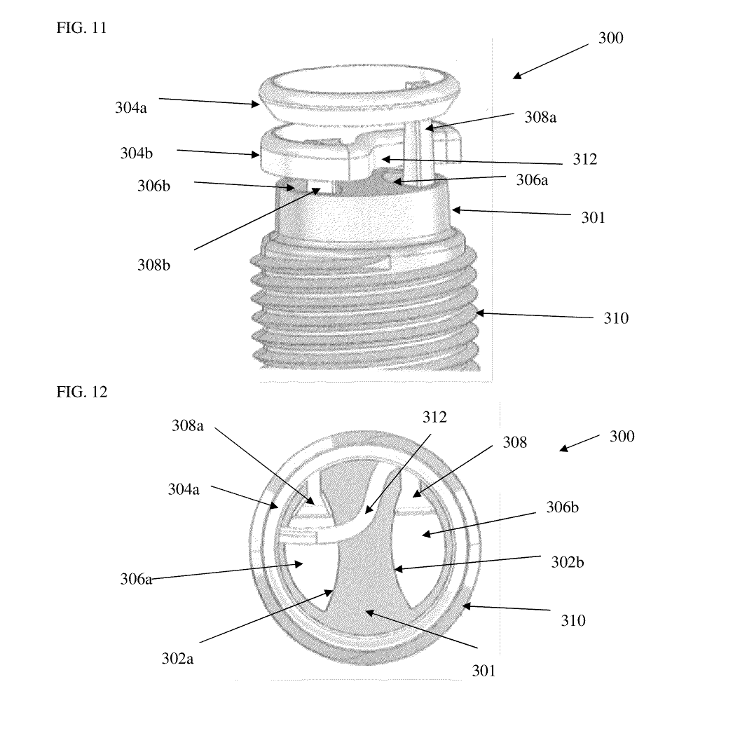

FIGS. 11-14 show embodiments for a pull tab system. FIGS. 11-12 show a first embodiment for a pull-tab system 300 attached at the nozzle end 80 of a two component, side-by-side dispensing system. FIG. 11 is isometric view of the pull-tab system 300. In this embodiment, the pull-tab system is integrally connected to the nozzle end 301 at breakoff portions 302a and 302b. The pull-tab system comprises two separate tear-off rings 304a and 304b that are respectively connected to removable panel portions 306a and 306b via respective connecting pieces 308a and 308b. Connecting pieces 308a and 308b initially extend upward from the panel portions 306a and 306b, and connects to their respective tear off rings 304a and 304b. Connecting piece 308a extends slightly longer than 308b, thereby vertically arranging each ring one above the other, without the rings contacting each other.

FIG. 12 provides a top view of the pull tab system 300 integrally connected with the nozzle end. As shown in FIG. 11, the outer edges of the panel portions 306a and 306b are integrally connected to the nozzle 301. A weakened region along the perimeter 302a and 302b of the removable panel portions 306a and 306b forms a predetermined breakoff. In this embodiment, the pull-tab system is manufactured together with the cartridge by means of an injection molding process to form an integrally molded cartridge. Alternatively, the pull-tab system can be separately molded with the removable panel portion 86 adhered to a weakened portion of the nozzle end.

As shown in FIGS. 11 and 12, the tear-off rings 304a and 304b have an inner and outer diameter generally similar to one another, with the inner diameter generally corresponding to the outside diameter of the nozzle end 300. As shown, the outer diameter of tear off rings 304a and 304b are less than the diameter of threads 310 so that an optional protective cap can be placed over the nozzle end. Further, tear-off rings 304a and 304b are maintained vertically spaced from one another. By spacing tear-off rings 304a and 304b one above the other, and separately connecting each tear-off ring to a breakoff portion, a user can open both conduits simultaneously or individually one at a time. Each conduit is opened initially by bending each tear-off ring upward about an axis that approximately extends upward through the transitions from the connecting piece. Each tear-off ring can be simultaneously or individually grasped by one or more fingers of one hand in order to exert an upwardly directed tensile force. The diameter of the tear-off rings can be chosen such that a finger can be inserted into both rings. As shown in FIGS. 11 and 12, a back portion 312 of the tear-off ring 304b curves around the connecting piece 308a by projecting inward towards the center axis of the cap and then reconnecting with the circular portion of the ring 304b. The back portion 312 curves around connecting piece 308a, while maintaining a sufficient ring diameter for an individual to grasp by a finger.

As shown in FIG. 12, the breakoff portions 306a and 306b are geometrically arranged on the nozzle in opposing semi-circular or “D” like shapes, with the connecting pieces 308a and 308b attached to the respective breakoff portions 302a and 302b towards the top portion of the “D” like shape.

Connecting pieces 308a and 308b initially extend upward from the panel portions 306a and 306b, and then laterally into a plane of their respective tear off rings 304a and 304b. Connecting piece 308a has a length greater than piece 308b to allow tear-off ring 304a to stack above 304b. The pull-tab can be in a variety of configurations with the purpose to provide a user with the ability to simultaneously or individually open each conduit of the nozzle end. Further, the pull-tab system provides a user with the ability to simultaneously or individually open each conduit with his or her hands and without the need for a separate tool such as a screw driver or a knife or other auxiliary means.

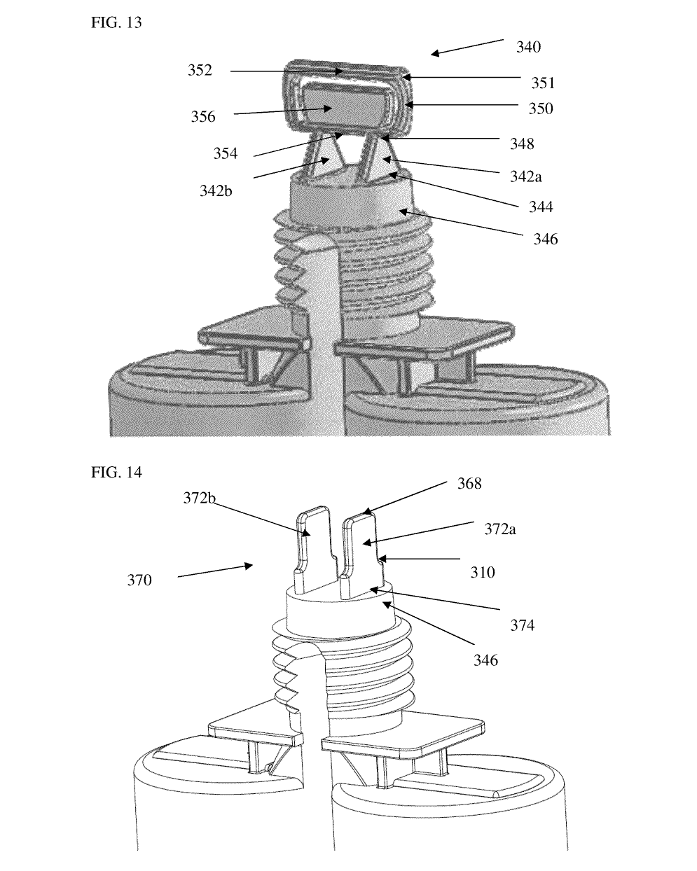

FIG. 13 is an isometric view of a second embodiment 340 of a pull tab system for a two component side-by-side cartridge. The pull tab system 340 comprises two connecting pieces 342a and 342b, each having a base portion 344 frangibly connected to the nozzle 346, and a top portion 348 integrally connected to a connecting ring 350. The connecting ring 350 comprises an outer ring 351 having an anterior section 352, a posterior section 354, and a panel portion 356. The posterior section 354 is integrally connected the top portion 348 of the connecting piece. The panel portion 356 is connectively attached to the interior of the posterior section 354. As shown here, the connecting ring is generally flattened when viewed from the side facing both cartridges. The panel portion can also be connectively attached to the anterior portion and/or other portions of the outer ring in order to further stabilize the movement of the panel prior to use. In use, a user inserts a finger through the outer ring, thereby bending back the panel portion at the posterior section of the outer ring. The user then grips the outer ring and applies a force to remove the frangible base portion. The panel portion reduces the risk of the accidental opening of the orifice. For example, the panel portion minimizes the risk that the outer ring is accidentally torn off. The panel portion can also provide a child proof safety system. In an alternative embodiment, the panel portion can comprise of one or more break off segments compatibly configured to plug the orifices after removal of the tab.

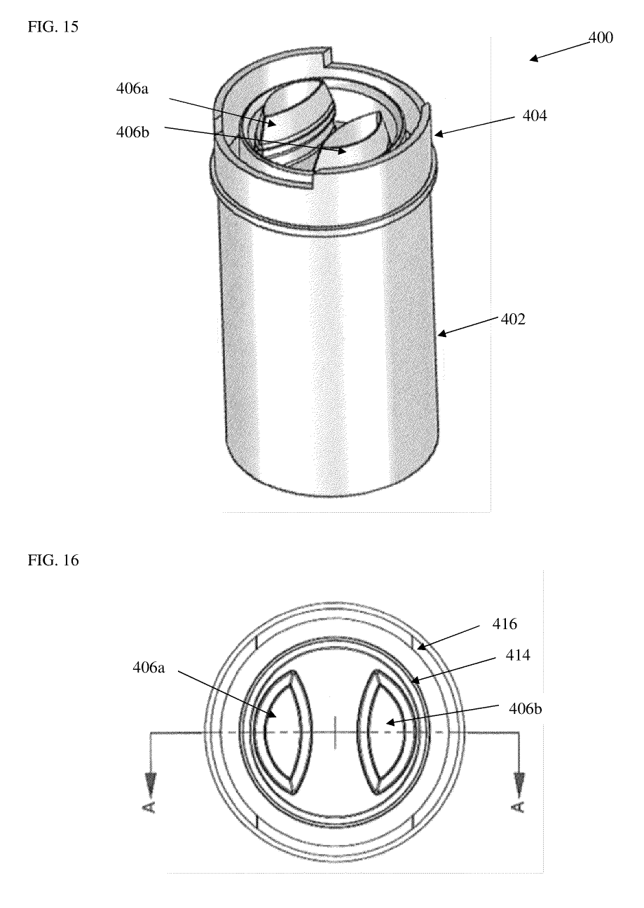

FIG. 14 is an isometric view of a third embodiment of a pull tab system 370 for a two component side-by-side cartridge. The pull tab system 370 comprises two prongs 372a and 372b, each having a base portion 374 frangibly connected to the nozzle 346, and a top portion 368. In this embodiment, the prongs are elongated and flattened, and are unconnected to each other at the top portion. Each prong is generally a mirror image. Each prong is configured to be disconnecting from the nozzle 346 by breaking a frangible seal formed between the base portion and the nozzle. Each top portion of the prong is dimensioned to matingly engage a corresponding orifice. The top portion of the prong engage and reseal the orifice when the prong is removed. In an embodiment, the prong is curved at the top portion to facilitate entry in the orifice.

The pull tab systems described herein can be dimensioned to allow a cap to be placed over the pull tab system, such as a cap described in the embodiment below.

Cap

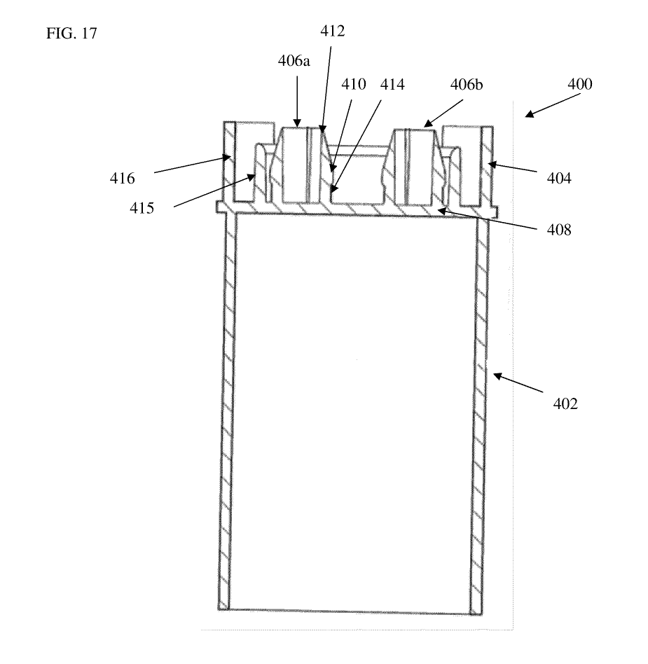

FIG. 15 is an isometric view of a closure or cap 400 for a two component, side-by-side cartridge. As shown, the cap is detached from the nozzle end of the two component cartridge. FIG. 16 is a top view of cap 400. FIG. 17 is a cross sectional view of cap 400 taken along line A-A as shown in FIG. 16.

Referring to FIGS. 15-17, the cap 400 is divided into two sections along its longitudinal axis: an overcap housing 402 and a plug housing 404. The cap is designed to geometrically align with the longitudinal axis of the cartridge. The overcap housing 404 is adapted to fit over the nozzle end of a compatible cartridge to provide protection for the tear-off elements of the nozzle end, such as for example the pull tab system shown in FIGS. 11-14. The lower end section of the overcap housing 402 further fits over external threads of the cartridge nozzle. When the overcap housing is removed from a nozzle end and tear-off elements are removed, the cap can be rotated 180 degrees perpendicular to its longitudinal axis, and the plug housing 404 attaches and reseals to the outlet openings in the nozzle end.

The plug housing 404 contains upwardly extending plugs 406a and 406b integrally connected to a dividing portion 408 that separates the overcap housing from the plug housing. As shown in FIG. 17, the plugs are tapered to facilitate entry into the conduits, with a diameter of the plug greater at a middle region 410 than at the top region 412. Further, the plugs can be hollow. Hollow plugs allow for additional flexibility at the middle and top regions. The middle region 410 of each plug is adapted to be disposed within the outlets of the nozzle end to effectively close off or seal the outlets. Plugs 406a and 406b further contain a lower region 414. As shown, the lower region 414 has a diameter less than the diameter of the middle region 412, so as to provide the middle region with greater degree of flexibility when resealing an outlet.

The plug housing further contains an inner wall 415 and wall portion 416. Inner wall 415 upwardly extends around plugs 406a and 406b, forming a ring integrally connected to the dividing portion 408. The inner wall 414 is slightly tapered at its top end so that the inner wall can snuggly fit around a compatible nozzle end with the plugs inserted into the nozzle end. One of the purposes of the inner wall 414 is to securely position the housing end onto the nozzle end so that the seals created by the plugs 406a and 406b are protected. Wall portion 416 upwardly extends around plugs 406a and 406b and the inner wall 415 so as to provide additional protection to plugs 406a and 406b.

The general dimensions of the overcap housing is determined by the general dimensions of the pull tab system and the profile of the nozzle end so that the overcap housing fits over and protects those components. The overcap housing can alternatively be threadably attachable to the nozzle section by complementary screw threads within the overcap housing. Alternatively, the overcap housing can be attached to the nozzle by a snap fitting element such as a projection on the nozzle wall and an aperture cut into the interior of the overcap.

Likewise, the general dimensions of the plug housing is determined by the general dimensions of the outlets and the profile of the nozzle end so that the plug housing fits snuggly fits over the nozzle end while the plugs reseal the outlets. Alternatively, the overcap housing can be attached to the nozzle end by a snap fitting element

The cap can be integrally made of the same single plastic as the cartridge. Alternatively, the cap can be made from a plastic different from the dispenser cartridge. The cap can also be made with a plastic having a greater flexibility than the dispenser cartridge, which allows the cap to flexibly bend and form a tight engagement to the dispenser cartridge. The plugs can be separately molded and attached to the plug housing, with the plugs made of a plastic having a greater flexibility than the housing.

A variety of extruding devices can be used to slide the piston forward. Examples include a caulking gun, pneumatic and hydraulic guns, a grease gun, sealing tools and food and pharmaceutical devices where a fluid is extruded by a moveable piston.

In an embodiment, a two-component, side-by-side cartridge apparatus, for storing and dispensing a product is disclosed. Each cartridge is sealable by a compatibly configured piston, and each cartridge comprises a dispensing end, a filling end, and a substantially rigid tube section. The dispensing end and filling end are located at opposite ends of the tube section along a longitudinal axis. The tube section comprises an exterior and interior surface, a cavity section, and at least one latch system proximal to the filling end. The latch system comprises a resiliently bendable latch, a latch entry end, a vent, and a casing. The latch connectively hinged to the casing at the latch entry end. The latch extends into the cavity section towards the dispensing end. The perimeter of the latch and casing define the area of the vent. The vent is initially in fluid communication with the exterior and interior surface, and traversal of the piston over the latch forms a sealed filling end.

In a specific embodiment to the two-component, side-by-side cartridge, the latch further comprises an elastic portion and a flange, the elastic portion protruding into the cavity section along a first plane forming a first axis, the elastic portion terminating within the cavity section at the flange.

In an even more specific embodiment to the two-component, side-by-side cartridge, the flange in the cartridge apparatus has a tapered surface, the tapered surface engagable against the piston to facilitate entry of the piston.

In yet an even more specific embodiment to the two-component, side-by-side cartridge, the flange in the cartridge apparatus has a shelf, the shelf engagable against the piston to restrict removal of the piston after entry.

Additionally, in a specific embodiment to the two-component, side-by-side cartridge the elastic portion of the cartridge apparatus has a forward angle formed between the longitudinal axis of the cartridge and the first axis, wherein the forward angle is initially no greater than 45 degrees and upon contact with the piston is adjustable to no less than 0 degrees. Further still, in a specific embodiment, the forward angle is initially no greater than 35 degrees and upon contact with the piston is adjustable to no less than 0 degrees. In another specific embodiment, the forward angle is initially no greater than 30 degrees and upon contact with the piston is adjustable to no less than 0 degrees.

In a further embodiment to the two-component, side-by-side cartridge, the casing in the cartridge apparatus has corner edges, and the latch attaches to at least one corner edge.

In yet another embodiment to the two-component, side-by-side cartridge, the casing in the cartridge apparatus comprises corner edges and an interior perimeter, and the latch attaches within the interior perimeter away from the corner edges.

In another specific embodiment to the two-component, side-by-side cartridge, each cartridge comprises a plurality of latch systems. In a more specific embodiment, each latch system is diametrically arranged along the tube section.

In another specific embodiment to the two-component, side-by-side cartridge, the latch system is monolithically formed with the cartridge.

In another embodiment to the two-component, side-by-side cartridge, a method for assembling a two component, side-by-side cartridge apparatus for storing and dispensing a product is disclosed, the method comprises inserting a liquid composition into the filling end of each cartridge as described any of the previous embodiments above; and inserting a piston into each of the filling ends.

In another embodiment to the two-component, side-by-side cartridge, a method of making a two component, side-by-side cartridge apparatus for storing and dispensing a product is disclosed, the method comprises: (a) injection molding a first polymeric material to form a side-by-side cartridge as described in any of the previous embodiments; and (b) injection molding a second polymeric material to form a piston, the piston adapted to be received within the cartridge.

In another embodiment, a two-component, side-by-side cartridge apparatus for storing and dispensing a product, each cartridge sealable by a compatibly configured piston, is disclosed, each cartridge comprises a dispensing end, a filling end, and a substantially rigid tube section, the dispensing end and filling end located at opposite ends of the tube section along a longitudinal axis, the tube section comprising an exterior and interior surface, a cavity section, and at least one latch system proximal to the filling end, the latch system comprises a resiliently bendable latch, a latch entry end, a latch locking end, a vent, and a casing, the latch connectively attached to the casing at opposing ends along the longitudinal axis at the latch entry end and at the latch locking end, and a section of the latch extending into the cavity section; wherein the perimeter of the latch and casing define an area of the vent, the vent in fluid communication with the exterior and interior surface; wherein traversal of the piston over the latch forms a sealed filling end.

In a specific embodiment to the two-component, side-by-side cartridge apparatus, the latch further comprises an elastic portion, a ridge, and a supporting section, the elastic portion extending into the cavity section along a first axis to form a ridge; and the supporting section connected to the elastic portion and extending back to the latch locking end.

In yet a more specific embodiment to the two-component, side-by-side cartridge apparatus the supporting section comprises a latch locking section and a bridge, the latch locking section connected at one end to the elastic portion and at an opposing end extending back towards the tube section to connect to the bridge, and the bridge connected at one end to the latch locking section and at an opposing end to the latch locking end.

In an even more specific embodiment to the two-component, side-by-side cartridge apparatus, the latch further comprises a flange, the flange extending from the elastic portion across the vent.

In yet a more specific embodiment to the two-component, side-by-side cartridge apparatus, the flange has a tapered surface, the tapered surface engagable against the piston to facilitate entry of the piston.

In yet an even more specific embodiment to the two-component, side-by-side cartridge apparatus, the flange has a shelf, the shelf engagable against the piston to restrict removal of the piston after entry.

In a more specific embodiment to the two-component, side-by-side cartridge apparatus, the elastic portion has a forward angle formed between the longitudinal axis of the cartridge and the first axis, wherein the forward angle is initially no greater than 45 degrees and upon contact with the piston is adjustable to no less than 0 degrees. In yet a more specific embodiment, the elastic portion has a forward angle formed between the longitudinal axis of the cartridge and the first axis, wherein the forward angle is initially no greater than 35 degrees and upon contact with the piston is adjustable to no less than 0 degrees. In an even more specific embodiment, the forward angle is initially no greater than 30 degrees and upon contact with the piston is adjustable to no less than 0 degrees.

In another embodiment, a method for assembling a two component, side-by-side cartridge apparatus for storing and dispensing a product, is disclosed, the method comprises inserting a liquid composition into the filling end of the cartridge as described in any of the embodiments above; and inserting a piston into the filling end tube.

In another embodiment, a method of making a two component, side-by-side cartridge apparatus for storing and dispensing a product is disclosed, the method comprises: (a) injection molding a first polymeric material to form a side-by-side cartridge as described in any of the embodiments above; and (b) injection molding a second polymeric material to form a piston, the piston adapted to be received within the cartridge.

In another embodiment, a one-component cartridge apparatus, for storing and dispensing a product is disclosed. The cartridge is sealable by a compatibly configured piston, and the cartridge comprises a dispensing end, a filling end, and a substantially rigid tube section. The dispensing end and filling end are located at opposite ends of the tube section along a longitudinal axis. The tube section comprises an exterior and interior surface, a cavity section, and at least one latch system proximal to the filling end. The latch system comprises a resiliently bendable latch, a latch entry end, a vent, and a casing. The latch connectively hinged to the casing at the latch entry end. The latch extends into the cavity section towards the dispensing end. The perimeter of the latch and casing define the area of the vent. The vent is initially in fluid communication with the exterior and interior surface, and traversal of the piston over the latch forms a sealed filling end. In a specific embodiment, the latch further comprises an elastic portion and a flange, the elastic portion protruding into the cavity section along a first plane forming a first axis, the elastic portion terminating within the cavity section at the flange. In an even more specific embodiment, the flange in the cartridge apparatus has a tapered surface, the tapered surface engagable against the piston to facilitate entry of the piston. In yet an even more specific embodiment, the flange in the cartridge apparatus has a shelf, the shelf engagable against the piston to restrict removal of the piston after entry.

Additionally, in a specific embodiment of the one-component cartridge apparatus, the elastic portion of the cartridge apparatus has a forward angle formed between the longitudinal axis of the cartridge and the first axis, wherein the forward angle is initially no greater than 45 degrees and upon contact with the piston is adjustable to no less than 0 degrees. Further still, in a specific embodiment, the forward angle is initially no greater than 35 degrees and upon contact with the piston is adjustable to no less than 0 degrees. In another specific embodiment, the forward angle is initially no greater than 30 degrees and upon contact with the piston is adjustable to no less than 0 degrees.

In a further embodiment of a one-component cartridge apparatus, the casing in the cartridge apparatus has corner edges, and the latch attaches to at least one corner edge.

In yet another embodiment of one-component cartridge apparatus, the casing in the cartridge apparatus comprises corner edges and an interior perimeter, and the latch attaches within the interior perimeter away from the corner edges.

In another specific embodiment of a one-component cartridge apparatus, the cartridge comprises a plurality of latch systems. In a more specific embodiment, each latch system is diametrically arranged along the tube section. In another specific embodiment, the latch system is monolithically formed with the cartridge.

In another embodiment, a one component cartridge apparatus for storing and dispensing a product, the cartridge sealable by a compatibly configured piston, is disclosed, the cartridge comprises a dispensing end, a filling end, and a substantially rigid tube section, the dispensing end and filling end located at opposite ends of the tube section along a longitudinal axis, the tube section comprising an exterior and interior surface, a cavity section, and at least one latch system proximal to the filling end, the latch system comprises a resiliently bendable latch, a latch entry end, a latch locking end, a vent, and a casing, the latch connectively attached to the casing at opposing ends along the longitudinal axis at the latch entry end and at the latch locking end, and a section of the latch extending into the cavity section; wherein the perimeter of the latch and casing define an area of the vent, the vent in fluid communication with the exterior and interior surface; wherein traversal of the piston over the latch forms a sealed filling end.

In a specific embodiment to the one component cartridge, the latch further comprises an elastic portion, a ridge, and a supporting section, the elastic portion extending into the cavity section along a first axis to form a ridge; and the supporting section connected to the elastic portion and extending back to the latch locking end.

In yet a more specific embodiment to the one component cartridge, the supporting section comprises a latch locking section and a bridge, the latch locking section connected at one end to the elastic portion and at an opposing end extending back towards the tube section to connect to the bridge, and the bridge connected at one end to the latch locking section and at an opposing end to the latch locking end.

In an even more specific embodiment to the one component cartridge, the latch further comprises a flange, the flange extending from the elastic portion across the vent. In yet a more specific embodiment, the flange has a tapered surface, the tapered surface engagable against the piston to facilitate entry of the piston. In yet an even more specific embodiment, the flange has a shelf, the shelf engagable against the piston to restrict removal of the piston after entry.

In a more specific embodiment to the one component cartridge, the elastic portion has a forward angle formed between the longitudinal axis of the cartridge and the first axis, wherein the forward angle is initially no greater than 45 degrees and upon contact with the piston is adjustable to no less than 0 degrees. In yet a more specific embodiment, the elastic portion has a forward angle formed between the longitudinal axis of the cartridge and the first axis, wherein the forward angle is initially no greater than 35 degrees and upon contact with the piston is adjustable to no less than 0 degrees. In an even more specific embodiment, the forward angle is initially no greater than 30 degrees and upon contact with the piston is adjustable to no less than 0 degrees.

In another embodiment, a method for assembling a one component cartridge apparatus for storing and dispensing a product is disclosed, the method comprises inserting a liquid composition into the filling end of the cartridge as described any of the previous embodiments above; and inserting a piston into the filling end.

In another embodiment to the one-component cartridge, a method of making a one component cartridge apparatus for storing and dispensing a product is disclosed, the method comprises: (a) injection molding a first polymeric material to form a cartridge as described in any of the previous embodiments; and (b) injection molding a second polymeric material to form a piston, the piston adapted to be received within the cartridge.

In another embodiment, a pull tab system for a two-component side-by-side cartridge is disclosed, which comprises a cartridge comprising a nozzle end including two conduit openings; and two tear-off elements separately connected to the nozzle end, each tear-off element comprising a breakoff panel portion frangibly connected to the cartridge nozzle such that the breakoff portions closes each conduit opening, wherein each tear-off element separately detachable by exerting tensile force upon the tear-off element by one or more fingers of a hand of a user without the use of any auxiliary means.

In a specific embodiment, each tear-off element comprises a top portion dimensioned to insertably plug the conduit opening.

In an even more specific embodiment, each tear-off element is attached to a tear-off ring.

Further still, in an even more specific embodiment, each tear-off element is spaced apart from each other and aligned in a plane perpendicular to the longitudinal axis of the cartridge.

In yet an even more specific embodiment, each tear-off ring is vertically spaced one above the other above.

In another embodiment, a pull tab system for a two-component side-by-side cartridge id disclosed, which comprises a cartridge comprising a nozzle end including two conduit openings; and two tear-off elements separately connected to the nozzle end, each tear-off element comprising a breakoff panel portion, a connecting piece, each connecting piece attached to a shared connecting ring, each panel portion frangibly connected to the nozzle end such that the breakoff portions closes each conduit opening, each connecting piece attached to the break off portions and to the connecting ring, wherein the tear-off elements simultaneously disconnect by exerting a tensile force upon the shared connecting ring by one or more fingers of a hand of a user without the use of any auxiliary means.

In a specific embodiment, the connecting ring further comprises a panel portion, the panel portion frangibly attached within the interior of the connecting ring.

In yet a more specific embodiment, the panel portion is compatibly adapatable to plug a conduit opening.

In another embodiment, a cap for a two-component side-by-side cartridge having a nozzle end with two adjacent conduit openings and a pull tab over each conduit openings, is disclosed, the cap comprises an overcap housing at one end of a longitudinal axis and a plug housing diametrically opposed at the other end of the axis, the overcap housing and nozzle end have interengaging formations for securing the overcap housing over nozzle end of the cartridge, and the plug housing having plug formations for subsequently resealing the conduit openings.

In a specific embodiment, the overcap housing and plug housing are a separated by a dividing portion, and both housings are attachable to the nozzle end by a rotation of the cap by 180 degrees along an axis perpendicular to its longitudinal axis of the cap.

In an even more specific embodiment, the plug formations are integrally connected to the dividing portion of the plug housing.

In yet an even more specific embodiment, the plug housing comprises an inner wall, the inner wall integrally connected at one end to the dividing portion, wherein the inner wall is adaptable to securely position the plug housing onto the nozzle end.

As used herein the transitional term “comprising,” (also “comprises,” etc.) which is synonymous with “having”, “including,” “containing,” or “characterized by,” is inclusive or open-ended and does not exclude additional, unrecited elements or method steps, regardless of its use in the preamble or the body of a claim.

The singular forms “a,” “an,” and “the” include plural referents unless the context clearly dictates otherwise.

The endpoints of all ranges directed to the same characteristic or component are independently combinable, and inclusive of the recited endpoint.

The word “or” means “and/or.”

Reference throughout the specification to “one embodiment”, “other embodiments”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed as the best mode contemplated for carrying out this invention, but that the invention will include all embodiments falling within the scope of the appended claims.

1. A cartridge apparatus, for storing and dispensing a product, the cartridge apparatus comprising a cartridge sealable by a compatibly configured piston, the cartridge comprising:
a dispensing end, a filling end, and a substantially rigid tube section, the dispensing end and filling end located at opposite ends of the tube section along a longitudinal axis, the tube section comprising an exterior and interior surface, a cavity section, and at least one latch system proximal to the filling end;
the latch system comprising a resiliently bendable latch, a latch entry end, a vent, and a casing, the latch connectively hinged to the casing, the latch extending into the cavity section towards the dispensing end;
wherein the perimeter of the latch and casing define the area of the vent, the vent in fluid communication with the exterior and interior surface, and
wherein traversal of the piston over the latch forms a sealed filling end.

2. The cartridge apparatus of claim 1 wherein the latch further comprises an elastic portion and a flange,
the elastic portion protruding into the cavity section along a first plane forming a first axis, the elastic portion terminating within the cavity section at the flange.

3. The cartridge apparatus of claim 2 wherein the flange has a tapered surface, the tapered surface engagable against the piston to facilitate entry of the piston.

4. The cartridge apparatus of claim 3 wherein the flange has a shelf, the shelf engagable against the piston to restrict removal of the piston after entry.

5. The cartridge apparatus of claim 4 wherein the elastic portion has a forward angle formed between the longitudinal axis of the cartridge and the first axis,
wherein the forward angle is initially no greater than 45 degrees and upon contact with the piston is adjustable to no less than 0 degrees.

6. The cartridge apparatus of claim 4 wherein the forward angle is initially no greater than 35 degrees and upon contact with the piston is adjustable to no less than 0 degrees.

7. The cartridge apparatus of claim 4 wherein the forward angle is initially no greater than 30 degrees and upon contact with the piston is adjustable to no less than 0 degrees.

8. The cartridge apparatus of claim 4 wherein the casing comprises corner edges, and the latch attaches to at least one corner edge.

9. The cartridge apparatus of claim 4 wherein the casing comprises corner edges and an interior perimeter, and the latch attaches within the interior perimeter away from the corner edges.

10. The cartridge apparatus of claim 4 wherein the cartridge comprises a plurality of latch systems.

11. The cartridge apparatus of claim 10 wherein each of the plurality of latch systems is diametrically arranged along the tube section.

12. The cartridge apparatus of claim 4 wherein the latch system is monolithically formed with the cartridge.

13. A method for assembling a cartridge apparatus for storing and dispensing a product, the cartridge apparatus comprising a cartridge sealable by a compatibly configured piston, the cartridge comprising: a dispensing end, a filling end, and a substantially rigid tube section, the dispensing end and filling end located at opposite ends of the tube section along a longitudinal axis, the tube section comprising an exterior and interior surface, a cavity section, and at least one latch system proximal to the filling end; the latch system comprising a resiliently bendable latch, a latch entry end, a vent, and a casing, the latch connectively hinged to the casing, the latch extending into the cavity section towards the dispensing end; wherein the perimeter of the latch and casing define the area of the vent, the vent in fluid communication with the exterior and interior surface, and wherein traversal of the piston over the latch forms a sealed filling end, the method comprising:
inserting a liquid composition into the filling end of the cartridge; and
inserting the piston into the filling end.

14. A method of making a cartridge apparatus for storing and dispensing a product, the cartridge apparatus comprising a cartridge sealable by a compatibly configured piston, the cartridge comprising: a dispensing end, a filling end, and a substantially rigid tube section, the dispensing end and filling end located at opposite ends of the tube section along a longitudinal axis, the tube section comprising an exterior and interior surface, a cavity section, and at least one latch system proximal to the filling end; the latch system comprising a resiliently bendable latch, a latch entry end, a vent, and a casing, the latch connectively hinged to the casing, the latch extending into the cavity section towards the dispensing end; wherein the perimeter of the latch and casing define the area of the vent, the vent in fluid communication with the exterior and interior surface, and wherein traversal of the piston over the latch forms a sealed filling end, the method comprising:
injection molding a first polymeric material to form the cartridge; and
injection molding a second polymeric material to form the piston, the piston adapted to be received within the cartridge.

15. A cartridge apparatus for storing and dispensing a product, the cartridge apparatus comprising a cartridge sealable by a compatibly configured piston, the cartridge comprising:
a dispensing end, a filling end, and a substantially rigid tube section, the dispensing end and filling end located at opposite ends of the tube section along a longitudinal axis, the tube section comprising an exterior and interior surface, a cavity section, and at least one latch system proximal to the filling end,
the latch system comprising a resiliently bendable latch, a latch entry end, a latch locking end, a vent, and a casing, the latch connectively attached to the casing at opposing ends along the longitudinal axis at the latch entry end and at the latch locking end, and a section of the latch extending into the cavity section;
wherein the perimeter of the latch and casing define an area of the vent, the vent in fluid communication with the exterior and interior surface;
wherein traversal of the piston over the latch forms a sealed filling end.

16. The cartridge apparatus of claim 15 wherein the latch further comprises:
an elastic portion, a ridge, and a supporting section, the elastic portion extending into the cavity section along a first axis to form the ridge;
and the supporting section connected to the elastic portion and extending back to the latch locking end.

17. The cartridge apparatus of claim 16 wherein the supporting section comprises a latch locking section and a bridge,
the latch locking section connected at one end to the elastic portion and at an opposing end extending back towards the tube section to connect to the bridge, and
the bridge connected at one end to the latch locking section and at an opposing end to the latch locking end.

18. The cartridge apparatus of claim 17 wherein the latch further comprises a flange, the flange extending from the elastic portion across the vent.

19. The cartridge apparatus of claim 18 wherein the flange has a tapered surface, the tapered surface engagable against the piston to facilitate entry of the piston.

20. The cartridge apparatus of claim 19 wherein the flange has a shelf, the shelf engagable against the piston to restrict removal of the piston after entry.

21. The cartridge apparatus of claim 16 wherein the elastic portion has a forward angle formed between the longitudinal axis of the cartridge and the first axis,
wherein the forward angle is initially no greater than 45 degrees and upon contact with the piston is adjustable to no less than 0 degrees.

22. The cartridge apparatus of claim 16 wherein the elastic portion has a forward angle formed between the longitudinal axis of the cartridge and the first axis,
wherein the forward angle is initially no greater than 35 degrees and upon contact with the piston is adjustable to no less than 0 degrees.

23. The cartridge apparatus of claim 16 wherein the forward angle is initially no greater than 30 degrees and upon contact with the piston is adjustable to no less than 0 degrees.

24. A method for assembling a cartridge apparatus for storing and dispensing a product, the cartridge apparatus comprising a cartridge sealable by a compatibly configured piston, the cartridge comprising: a dispensing end, a filling end, and a substantially rigid tube section, the dispensing end and filling end located at opposite ends of the tube section along a longitudinal axis, the tube section comprising an exterior and interior surface, a cavity section, and at least one latch system proximal to the filling end; the latch system comprising a resiliently bendable latch, a latch entry end, a latch locking end, a vent, and a casing, the latch connectively attached to the casing at opposing ends along the longitudinal axis at the latch entry end and at the latch locking end, and a section of the latch extending into the cavity section; wherein the perimeter of the latch and casing define an area of the vent, the vent in fluid communication with the exterior and interior surface; wherein traversal of the piston over the latch forms a sealed filling end, the method comprising:
inserting a liquid composition into the filling end of the cartridge; and
inserting the piston into the filling end tube.

25. A method of making a cartridge apparatus for storing and dispensing a product, the cartridge apparatus comprising a cartridge sealable by a compatibly configured piston, the cartridge comprising: a dispensing end, a filling end, and a substantially rigid tube section, the dispensing end and filling end located at opposite ends of the tube section along a longitudinal axis, the tube section comprising an exterior and interior surface, a cavity section, and at least one latch system proximal to the filling end; the latch system comprising a resiliently bendable latch, a latch entry end, a latch locking end, a vent, and a casing, the latch connectively attached to the casing at opposing ends along the longitudinal axis at the latch entry end and at the latch locking end, and a section of the latch extending into the cavity section; wherein the perimeter of the latch and casing define an area of the vent, the vent in fluid communication with the exterior and interior surface; wherein traversal of the piston over the latch forms a sealed filling end, the method comprising:
injection molding a first polymeric material to form the cartridge; and
injection molding a second polymeric material to form the piston, the piston adapted to be received within the cartridge.

26. A pull tab system for a two-component side-by-side cartridge comprising:
a cartridge comprising a nozzle end including two conduit openings; and
two tear-off elements separately connected to the nozzle end, each tear-off element comprising a breakoff panel portion frangibly connected to the cartridge nozzle such that the breakoff portions closes each conduit opening,
wherein each tear-off element separately detachable by exerting tensile force upon the tear-off element by one or more fingers of a hand of a user without the use of any auxiliary means.

27. The pull-tab system according to claim 26, wherein each tear-off element comprises a top portion dimensioned to insertably plug the conduit opening.

28. The pull-tab system according to claim 26, wherein each tear-off element is attached to a tear-off ring.

29. The pull-tab system according to claim 28, wherein each tear-off element is spaced apart from each other and aligned in a plane perpendicular to the longitudinal axis of the cartridge.

30. The pull-tab system according to claim 29, wherein each tear-off ring is vertically spaced one above the other above.

31. A pull tab system for a two-component side-by-side cartridge comprising:
a cartridge comprising a nozzle end including two conduit openings; and
two tear-off elements separately connected to the nozzle end, each tear-off element comprising a breakoff panel portion, a connecting piece, each connecting piece attached to a shared connecting ring,
each panel portion frangibly connected to the nozzle end such that the breakoff portions closes each conduit opening,
each connecting piece attached to the break off portions and to the connecting ring,
wherein the tear-off elements simultaneously disconnect by exerting a tensile force upon the shared connecting ring by one or more fingers of a hand of a user without the use of any auxiliary means.

32. The pull tab system of claim 31 wherein the connecting ring further comprises a panel portion, the panel portion frangibly attached within the interior of the connecting ring.

33. The pull tab system of claim 32 wherein the panel portion is compatibly adapatable to plug a conduit opening.

34. An cap for a two-component side-by-side cartridge having a nozzle end with two adjacent conduit openings and a pull tab over each conduit openings, the cap comprising:
an overcap housing at one end of a longitudinal axis and a plug housing diametrically opposed at the other end of the axis,
the overcap housing and nozzle end have interengaging formations for securing the overcap housing over nozzle end of the cartridge, and
the plug housing having plug formations for subsequently resealing the conduit openings.

35. The cap of claim 34, wherein the overcap housing and plug housing are a separated by a dividing portion, and both housings are attachable to the nozzle end by a rotation of the cap by 180 degrees along an axis perpendicular to its longitudinal axis of the cap.

36. The cap of claim 35, wherein the plug formations are integrally connected to the dividing portion of the plug housing.

37. The cap of claim 35, wherein the plug housing comprises an inner wall, the inner wall integrally connected at one end to the dividing portion, wherein the inner wall is adaptable to securely position the plug housing onto the nozzle end.

38. The cartridge apparatus of claim 1, comprising a first and a second of the cartridge configured as a two-component side-by-side cartridge apparatus.

39. The cartridge apparatus of claim 1, wherein the latch is connectively hinged to the casing at the latch entry end.

40. The cartridge apparatus of claim 2, wherein the flange comprises a shape that generally mirrors a curvature of the interior surface of the tube section.

41. The method of claim 13, wherein the cartridge apparatus comprises a first and a second of the cartridge configured as a two-component side-by-side cartridge apparatus, the method further comprising:
inserting respective portions of the liquid composition into the filling end of each cartridge; and
inserting respective ones of the piston into each of the filling ends.

42. The method of claim 14, wherein the cartridge apparatus comprises a first and a second of the cartridge configured as a two-component side-by-side cartridge apparatus, the method further comprising:
injection molding a first polymeric material to form the side-by-side cartridge; and
injection molding a second polymeric material to form the piston, the piston adapted to be received within each of the side-by-side cartridge.

43. The cartridge apparatus of claim 15, comprising a first and a second of the cartridge configured as a two-component side-by-side cartridge apparatus.

44. The method of claim 24, wherein the cartridge apparatus comprises a first and a second of the cartridge configured as a two-component side-by-side cartridge apparatus, the method further comprising:
inserting a liquid composition into the filling end of each cartridge; and
inserting respective ones of the piston into each of the filling ends.

45. The method of claim 25, wherein the cartridge apparatus comprises a first and a second of the cartridge configured as a two-component side-by-side cartridge apparatus, the method further comprising:
injection molding a first polymeric material to form the side-by-side cartridge; and
injection molding a second polymeric material to form the piston, the piston adapted to be received within each of the side-by-side cartridge.
